(19) United States
(12) Patent Application Publication
(10) Pub. No.: US 2005/0082775 A1
(43) Pub. Date: Apr. 21, 2005

(54) Shopping-cart motion-restraining device and method for using the shopping-cart motion-restraining device

(76) Inventor: Rita Slager, Camp Lake, WI (US)

Correspondence Address: JANSSON, SHUPE & MUNGER, LTD, 245 MAIN STREET, RACINE, WI, 53403, US

(21) Appl. No.: 10/689,288

(22) Filed: Oct. 20, 2003

(51) Int. Cl. B62D 39/00

(52) U.S. Cl. 280/33.992

(57) ABSTRACT

This invention involves a restraining device for preventing undesired motion of a shopping cart. The invention comprises: (a) a bracket for fixed attachment to the shopping-cart frame; (b) an elongate arm; (c) a non-slippery engagement surface; and (d) a pivot located between the bracket and the elongate arm. The elongate arm has a first end and a second end, and is attached with respect to the bracket. The engagement surface is attached with respect to the first end. The engagement surface is configured and arranged for engagement with the horizontal surface. It is another aspect of the invention to provide a method for selectively prohibiting the movement of a shopping cart.

### FIELD OF THE INVENTION

The invention relates to shopping cart, particularly to restraining means for shopping carts.

### BACKGROUND OF THE INVENTION

Shopping carts are typically outfitted with four single-axle wheels designed for freewheeling in order to allow a shopper to easily push the cart when heavily laden with groceries and other potential purchases. It is this design for ease of operation which also allows for accidental motion. It is well known that grocery carts will travel on their own with minimal impetus. It is frequently the case that parking lots are pitched for purposes of rainwater run-off; that minimal pitch is sufficient to allow a grocery cart left unattended to move. These moving grocery carts (regardless of whether the unintentional movement is occasioned by gravity or wind) can and do strike into cars causing paint damage. Payout for such damage by stores and their insurers has led to increasing the number of cart corrals (to encourage shopper return of the empty cart to a secure location to reduce the incidents of motion of unattended, empty carts) and cart baskets being made of plastic (to reduce the amount of damage inflicted by contact of a moving cart with a car). Such efforts are designed to affect the symptom (incidence and extent of damage), but are not preventative of the motion in the first instance.

Moreover, it is also frequently observed that young, ambulatory children, while left unattended while the parent is putting grocery bags into the car, may take the cart for a “joy ride”. When children are momentarily left alone with a cart, it is frequently observed that the child will push the cart potentially into parking lot traffic, parked cars, or other shoppers.

This significant problem of cart movement (regardless of whether from children or environmental conditions) has been unsuccessfully addressed by a several devices. Various shopping-cart break devices exist in the prior art. Included within the prior art are six patents: U.S. Pat. No. 4,610,454 (issued to Gill), U.S. Pat. No. 5,035,445 (issued to Poulin), U.S. Pat. No. 4,944,209 (issued to Sedlack), U.S. Pat. No. 4,815,569 (issued to Norman), U.S. Pat. No. 4,579,359 (issued to Schwartz) and U.S. Pat. No. 5,630,600 (issued to Pasillas).

Most of the prior-art brakes dealing with shopping carts are wheel-engaging. Such wheel-engaging devices are disfavored by retailers as they may spontaneously deploy when the cart is parked in a cart corral. Such inadvertent deployment is especially troublesome when the parked cart is nested with other parked carts.

Several of the of the prior-art cart brakes engage the ground (e.g., the devices of Sedlack, Norman, and Schwartz). These devices engage the ground and lift the wheels up from contact with the ground. Such devices are difficult to deploy on fully-loaded carts, heavily laden with groceries or home-improvement store purchases. Such devices prove impossible for certain elderly or incapacitated individuals.

The '445 patent to Poulin shows a foot peddle-engaging brake for carts. Significantly, both the disclosure and the claims require two foot peddles. Particularly, the use of the cross bar in Poulin would not be useful for shopping carts which necessarily nest.

That the prior art has been unsuccessful in addressing the problem of run-away carts is evidenced by the lack common or widespread use of successful devices on carts throughout the United States.

A shopping-cart brake which allows nesting of the cart for storage would be an important improvement in the art.

### OBJECTS OF THE INVENTION

It is an object of the invention to provide an improved shopping-cart brake overcoming some of the problems and shortcomings of the prior art, including those referenced above.

Another object of the invention is to provide a shopping-cart brake which is easily deployable.

Another object of the invention is to provide a shopping-cart brake which allows for retrofitting existing carts.

Still another object of the invention is to provide a shopping-cart brake which is easily retractable.

Yet another object of the invention is to provide a shopping-cart brake which does not obstruct the nesting of shopping carts in storage.

Another object of the invention is to provide a shopping-cart brake which prohibits the front, steering wheels from revolving about the back wheels when the brake is engaged.

It is another object of the invention to provide a method which is easily practiced whereby children under the control or supervision of an adult can be prevented from pushing the shopping cart into the path of cars in a parking lot.

It is yet another object of this invention to provide a method which is easily practiced whereby unaccompanied shoppers may secure the cart which the shopper had used to transport purchases to the shopper's car, while the shopper transfers those purchases to the car.

It is still another object of the invention to provide a shopping cart brake which is able to be used by people of all abilities.

How these and other objects are accomplished will become apparent from the following descriptions and the drawings.

### SUMMARY OF THE INVENTION

This invention involves a restraining device for preventing undesired motion of a shopping cart. The shopping carts are generally of the type having a frame, more specifically with a horizontal U-shaped bottom portion. The shopping cart has a plurality of wheels, most usually four single-axle wheels spaced, along the U-shaped bottom portion, to allow the cart to roll over a substantially planar, horizontal surface, such as a grocery store floor or parking lot. The invention comprises: (a) a bracket for fixed attachment to the shopping-cart frame; (b) an elongate arm; (c) a non-slippery engagement surface; and (d) a pivot located between the bracket and the elongate arm. The elongate arm has a first end and a second end, and is attached with respect to the bracket. The invention does not require that the elongate arm be strictly linear. The engagement surface is attached with respect to the first end. The engagement surface is configured and arranged for engagement with the horizontal surface. The pivot allows for rotation of the elongate arm with respect to the bracket (and the frame).

It is preferable for the restraining device to further have a locking element. The locking element holds the elongate arm in a particular position, but may be overcome by application of a pressure greater than a threshold pressure. It is more preferable for the restraining device to further have a restoring device located between the elongate arm and the frame. The restoring device may be a spring. The spring may be, but is not required to be, either a compressional spring or a torsional spring, the latter of which is illustrated in the U.S. patent issued to Schwinn (U.S. Pat. No. 2,396,890).

It is more preferable for the non-slippery engagement surface to be a plate-like friction pad. The restraining mechanism may have a pivot between the first end and the pad to allow for rotation of the pad with respect to the arm.

Many types of shopping carts have two forward wheels. These wheels are attached to the frame at wheel-attachment points. Between the wheel-attachment points is a forward portion of the frame, which forward portion is typically, generally linear. Perpendicular to the ground is a geometric plane extending through the forward potion. In such cases, it is preferable for the pivot to be configured and arranged to permit retraction of the arm in that geometric plane, perpendicular to the forward portion.

In a preferred embodiment, an arm-length adjusting device is located between the first and second ends. The arm-length adjusting device allows for the adjusting of the length of the elongate arm.

Another aspect of the invention is the provision of a shopping-cart restraining device. The shopping-cart restraining device has an elongate member pivotably engaged with respect to the shopping cart, having a distal end and a proximal end; a non-slippery engagement surface pivotably attached with respect to the distal end, for engagement with the horizontal surface; and a locking mechanism to disengagingly lock the arm with respect to the cart in a position whereby the engagement surface is maintained in contact with the horizontal surface.

It is another aspect of the invention to provide a method for selectively prohibiting the movement of a shopping cart. The shopping cart is of the type having a plurality of wheels for movement over a planar surface such as a parking lot or store floor. The method comprises the steps of: (1) affixing to the cart a restraining device; and (2) deploying an elongate member of the restraining device whereby an engagement surface of the restraining device is in engagement with the planar surface. The restraining device has: (a) a bracket for fixed attachment to a frame; (b) an elongate member having a first end and a second end, pivotably attached with respect to the bracket; and (c) a non-slippery engagement surface attached with respect to the first end, configured and arranged for engagement with the horizontal surface;

It is preferable if the restraining device used in the method has a locking mechanism to releaseably hold the elongate member in a stationary position relative to the shopping cart when the non-slippery engagement surface is in engagement with the planar surface. It is preferable that the locking mechanism is deployable through the application of foot pressure. It is more preferable for the locking mechanism to be retractable (released) from its deployed (planar-surfaced engaged) by the addition of energy. The impartation of energy could, for example, be applied through the foot kicking of the elongate member. The impartation of energy could also be accomplished through the hand shifting of the cart to impart translated motion to the elongate member, which elongate member is fixedly attached to the cart and frictionally attached through its non-slippery engagement surface to the planar surface; thereby, through the imparted energy, a “break” occurs at the pivot, allowing the elongate member to retract.

As mentioned above, carts typically have two forward wheels, attached to the frame at wheel-attachment points, and the frame has a forward portion dispensed between the wheel-attachment points. The pivot is configured and arrangement to permit retraction of the elongate member in a planar manner, perpendicular to the forward portion. An additional preferred step is (3) applying hand force to the basket portion attached with respect to the frame, in a direction parallel to the forward portion in an amount sufficient to release the locking mechanism. Alternatively, (3) the locking mechanism may be released by the application of force with respect to the elongate member by the foot of a user.

### BRIEF DESCRIPTION OF THE DRAWINGS

FIG. 1 is a prospective view of a shopping-cart motion-restraining device attached to the front bar of a standard shopping cart.

FIG. 2 is a cut-away view of the shopping-cart motion-restraining device of FIG. 1 in a retracted position.

FIG. 3 is a cut-away front view of the shopping-cart motion-restraining device of FIG. 1 in an extended position.

FIG. 4 is a front cross-sectional diagram of the shopping-cart motion-restraining device of FIG. 3.

FIG. 5 is a prospective view of the shopping-cart motion-restraining device in an extended position attached with respect to the side of the underframe of a standard shopping cart.

FIG. 6 is a front view of another embodiment of a shopping-cart motion-restraining device.

### DETAILED DESCRIPTION OF PREFERRED EMBODIMENTS

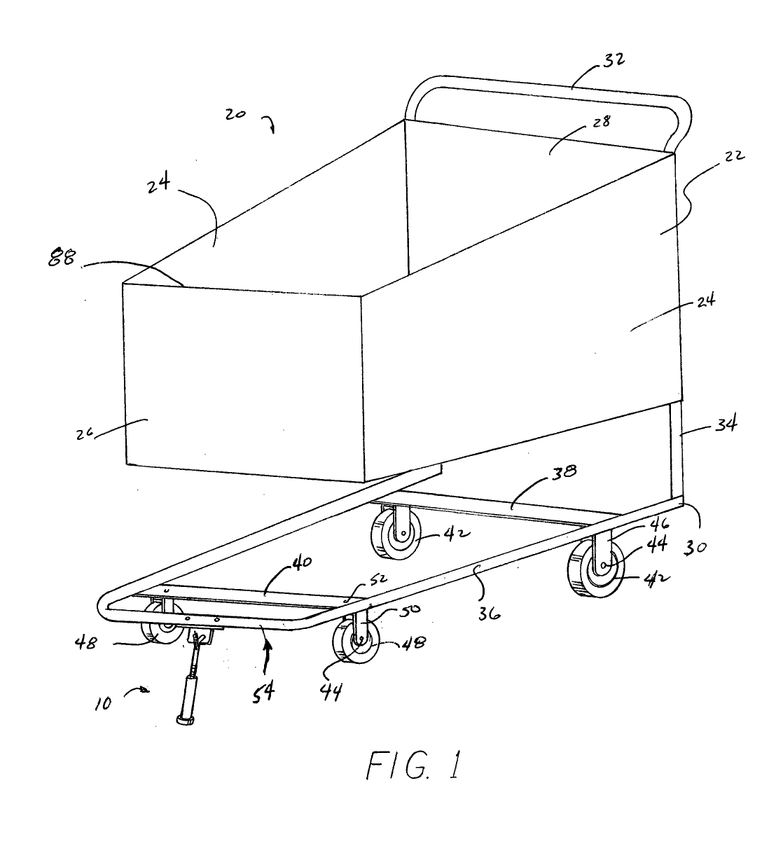

FIG. 1 shows device 10 attached to a shopping cart 20. Shopping cart 20 has basket portion 22. Basket portion 22 is composed of two sidewalls 24, front wall 26 and rear wall 28 and floor (not shown). Sidewalls 24 are trapezoidal while front wall 26 and rear wall 28 are rectangular. Rear wall 28 is dimensioned to be larger than front wall 26 such that when assembled, basket portion 22 has a trapezoidal configuration when viewed from the top.

Integral with basket portion 22 is frame 30.

Frame 30 has handle portion 32 integral with tubular vertical support 34. Attached perpendicularly to vertical support 34 is tubular horizontal frame member 36. Tubular horizontal frame member 36 is u-shaped, creating an open area at the back of the shopping cart. Tubular horizontal frame member 36 is stabilized by rear cross member 38 and front cross member 40.

Attached to rear cross member 38 are rear wheels 42. Axles 44 engage wheels 42 to saddle guide 46. Saddle guide 46 is typically welded to either rear cross member 38 or tubular horizontal frame member 36. When installed, wheels 42 freely rotate around axle 44 allowing for unidirectional motion of the cart 20.

Front caster wheels 48 are attached through axles 44 to front saddle guide 50. Front saddle guide 50 is pivotably attached to front cross member 40 by pin 52. Pivotable attachment of front saddle guide 50 to front cross member 40 through pin 52 allows for steering movement of cart 20.

Front portion 54 of u-shaped tubular horizontal frame member 36 is frequently non-planar with the remainder of u-shaped tubular horizontal frame member 36, most frequently providing a dip down toward the rolling surface. This dip to front portion 54 allows for nesting of carts 20 in storage.

Attached to front portion 54 is device 10.

As better seen in FIG. 3, device 10 has base plate 56. Pivotably attached to base plate 56 is rod 58. Rod 58 is attached to base plate 56 through rivet 60.

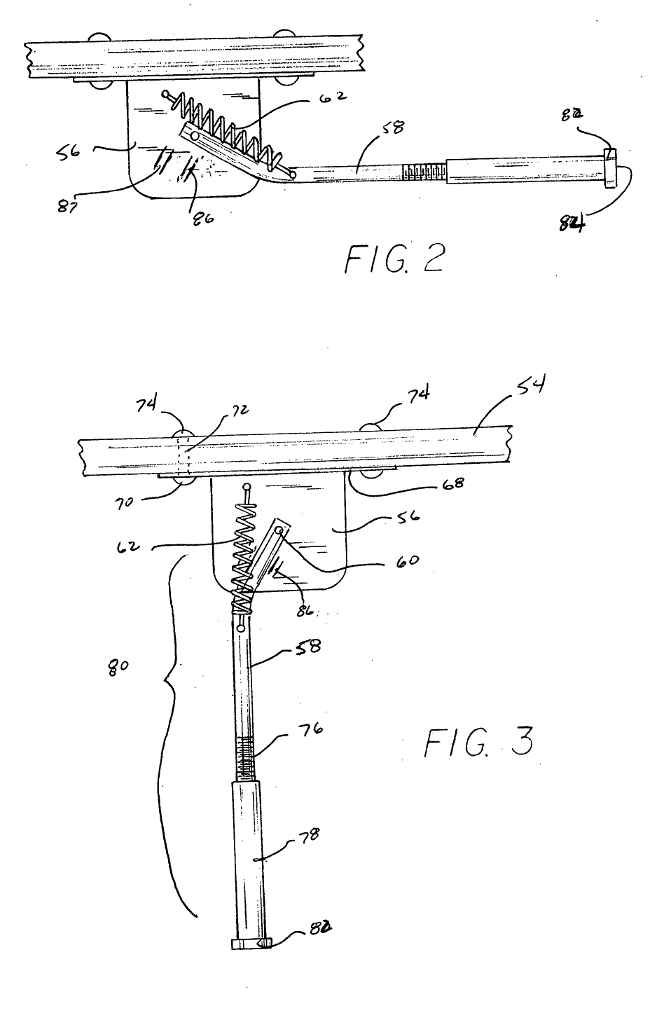

As seen in FIGS. 2 and 3, the range of motion of rod 58 with respect to base plate 56 is at least 90°. Spring 62 is attached to base plate 56 by means of spring rivet 64 and to rod 58 by rod pin 66.

Base plate 56 is L-shaped having attachment portion 68. Attachment portion 68 has two apertures through which attachment bolts 70 may extend up through and then through frame aperture 72 to be secured by acorn nut 74.

At the distal end of rod 58 is threaded adjustment portion 76. Tubular foot portion 78 has complementary threads within two engage threaded portion 76 in a male/female engagement. Together, rod 58 and foot portion 78 make up an engagement arm 80. At the distal end of tubular foot portion 78 is foot pad 80.

Foot pad 80 has frictional engagement surface 82 configured to maximize the coefficient of friction.

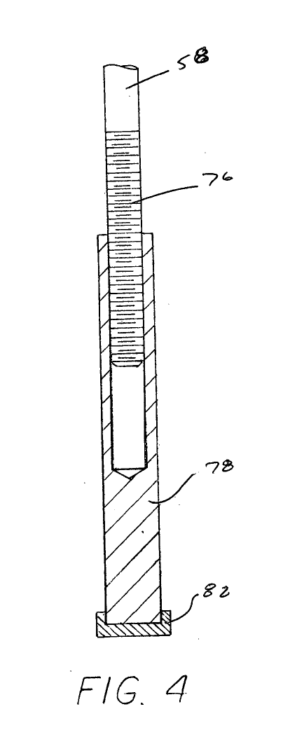

As better seen in FIG. 4, by rotation of foot portion 78 along threaded portion 76, length of arm 80 may be adjusted.

In operation, restraining device 10 is attached to cart 20 through bolts and nuts 70, 74 to front portion 54 as seen in FIG. 1. When retracted (as seen in FIG. 2), rod 58 is roughly horizontal to the surface over which cart 20 would roll. When it is desired to have the cart remain in a stationery position, foot pressure is applied to arm 80 typically at outer surface of foot portion 78 to cause rod 58 to rotate about rivet 60 into deployed position (as seen in FIG. 3). In deployed position, friction foot surface 84 frictionally engages ground surface upon which cart would roll.

When deployed, foot pressure which caused rotation about base plate 56 caused rod 58 to overcome raised portion 86 of base plate 56. Raised portion 86 provides a slight crest above the surface of base plate 56. Once rod 58 overcomes and passes raised portion 86 (as seen in FIG. 3), rod 58 is kept in place adjacent to raised portion 86 and raised stop 87 as raised portion 86 and raised stop 87 create a potential well.

In order to be retracted, sufficient pressure must be imparted to rod 58 in order to overcome the potential well created by raised portion 86 constraining it to the deployed position. Retraction is advantageously obtained by the shopper applying hand pressure to the upper edge 88 of front panel 26. Hand pressure applied would cause a leftward motion (from a position looking at front panel 26) thereby creating a clockwise motion (as seen from advantage above shopping cart 20). Such hand pressure is translated through cart 20 through its frame 30 causing contradictory pressure at rivet 60. Stated another way, the hand force applied indirectly to frame 30 is initially opposed by the frictional engagement of friction foot surface 84 with the surface over which the cart rolls. The tendency to allow for the rod 58 to rotate with respect to base plate 56 is initially inhibited by raised portion 86 until such time as the potential well is overcome and rotational movement is obtained. Further retraction is facilitated by spring 62 which is extended from its natural state in the retracted position into its extended state in the deployed position.

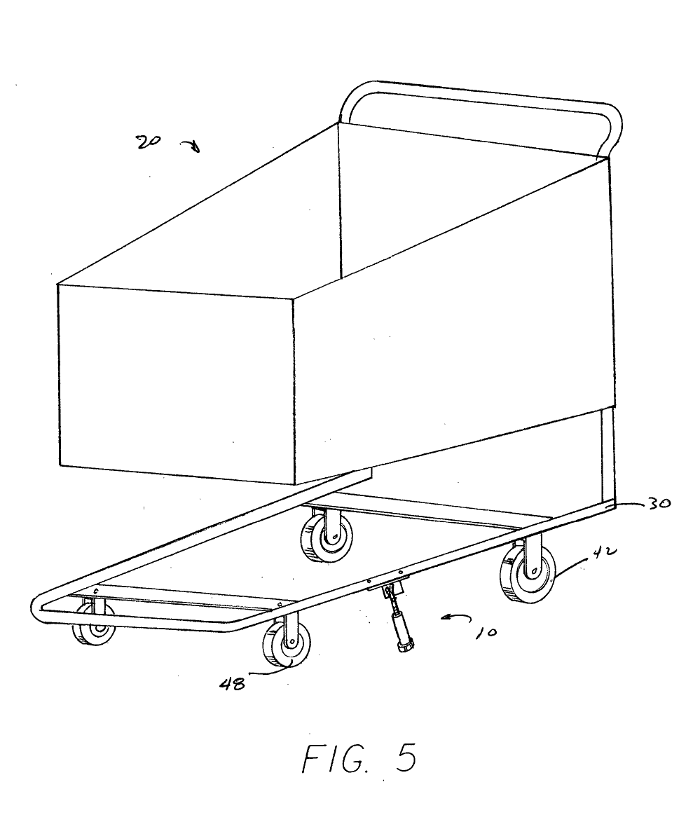

The inventor has found that positioning of restraining device 10 on front of frame 54 has the advantageous benefits. Through its location between two front wheels 44, when deployed, restraining device 10 most directly effects both front wheels 48. Alternatively, however, as seen in FIG. 5, device 10 may be placed on other portions of tubular frame 30. Particularly, as shown, device 10 is affixed to frame 30 at a point between front wheel 48 and rear wheel 42. Deployment is accomplished in the same manner as described above. Retraction, however, is obtained by an imparting of pressure to frame in a forward direction (forward direction for this purpose being defined as the ordinary forward direction of the cart when in use).

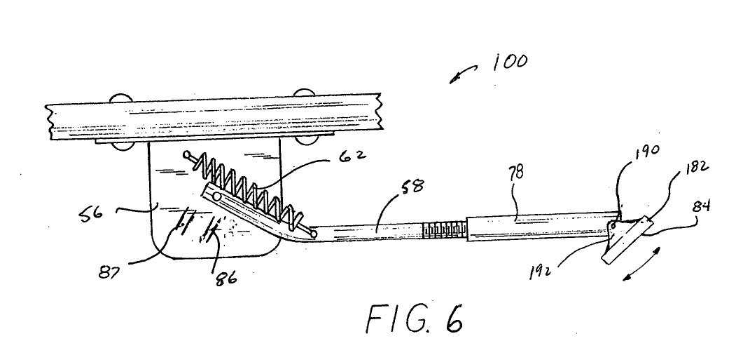

FIG. 6 shows another version of restraining device 100. Restraining device 100 has base plate 56, rod 58, spring 62 and other components as previously described with regard to restraining device 10. Restraining device 100, however, has foot 182 pivotably attached to foot portion 78 by means of pin 190 extending through guides 192 through aperture (obscured by pin 190) into foot portion 78. Such arrangement allows foot 182 to rotate with regard to foot portion 78.

Rather than acquiring drilling holes into tubular frame 30 of cart 20, the bracket associated with restraining device 110 includes bracket top plate 200 which has four apertures through which four separate bolts 202 can extend. Further, base plate attachment portion 168 has four complementary apertures 167 through which bolts 202 can extend. Bolts 202 are secured by acorn nuts 74.

As described above, in the summary section, another variation for the spring would be an internal torsional spring, which although more costly to produce, is more aesthetically pleasing and safer in operation.

While the principles of the invention have been shown and described in connection with but a few embodiments, it is to be understood clearly that such embodiments are by way of example and are not limiting.

1. A restraining device for preventing undesired motion of a shopping cart of the type having a frame with a plurality of wheels attached thereto for rolling over a substantially planar, horizontal surface, comprising:
a bracket for fixed attachment to the frame;
an elongate arm having a first end and a second end, attached with respect to the bracket;
a non-slippery engagement surface attached with respect to the first end, configured and arranged for engagement with the horizontal surface; and
a pivot located between the bracket and the elongate arm.

2. The restraining device of claim 1 further comprising a locking element.

3. The restraining device of claim 2 further comprising a restoring device dispensed between the elongate arm and the frame.

4. The restraining device of claim 3 wherein the non-slippery engagement surface is a plate-like friction pad.

5. The restraining device of claim 4 further comprising a rotation mechanism between the first end and the pad to allow for rotation of the pad with respect to the arm.

6. The restraining device of claim 3 wherein the elongate arm is non-linear.

7. The restraining device of claim 3 wherein the cart has two forward wheels, attached to the frame at wheel-attachment points, and the frame has a forward portion dispensed between the wheel-attachment points, and wherein the pivot is configured and arranged to permit retraction of the arm in a plane perpendicular to the forward portion.

8. The restraining device of claim 3 further comprising an arm-length adjusting device located between the first and second ends whereby a length of the arm may be adjusted.

9. A shopping-cart restraining device for restraining shopping carts of the type having a substantially horizontal frame with a plurality of wheels attached thereto for motion over a planar surface, comprising:
an elongate member pivotably engaged with respect to the shopping cart, having a distal end and a proximal end;
a non-slippery engagement surface pivotably attached with respect to the distal end, for engagement with the horizontal surface; and
a locking mechanism to disengagingly lock the arm with respect to the cart in a position whereby the engagement surface is maintained in contact with the horizontal surface.

10. A method for selectively prohibiting the motion of a shopping cart of the type having a plurality of wheels for movement over a planar surface, attached to a frame, comprising the steps of:
affixing to the cart a restraining device of the type having:
a bracket for fixed attachment to a frame;
an elongate member having a first end and a second end, pivotably attached with respect to the bracket; and
a non-slippery engagement surface attached with respect to the first end, configured and arranged for engagement with the horizontal surface; and
deploying the arm whereby the engagement surface is in engagement with the planar surface.

11. The method of claim 10 wherein the restraining device has a locking mechanism to releaseably hold the elongate member in a stationary position.

12. The method of claim 11 wherein the locking mechanism is engaged through the application of foot pressure.

13. The method of claim 11 wherein the locking mechanism is released by the addition of energy.

14. The locking mechanism of claim 13 wherein the cart has two forward wheels, attached to the frame at wheel-attachment points, and the frame has a forward portion dispensed between the wheel-attachment points and parallel to the surface, and wherein the pivot is configured and arrangement to permit retraction of the elongate member in a planar manner, perpendicular to the forward portion, and comprising the additional step of:
applying hand force to a basket attached with respect to the frame, in a direction parallel to the forward portion in an amount sufficient to release the locking mechanism.

15. The method of claim 13 comprising the additional step of: applying force by the foot of a user with respect to the elongate member, in an amount sufficient to release the locking mechanism.
